(19) United States
(12) Patent Application Publication
(10) Pub. No.: US 2026/0240122 A1
(43) Pub. Date: Aug. 20, 2026

(54) BIRD HEATING APPARATUS

(71) Applicant: Yue Yao, Atlanta, GA (US)

(72) Inventor: Guanghui Rao, Hunan Province (CN)

(21) Appl. No.: 19/540,716

(22) Filed: Feb. 15, 2026

(30) Foreign Application Priority Data
Feb. 18, 2025 (CN) 202520265418.9

(51) Int. Cl. A01K 39/012; A01K 39/014; H05B 3/06; H05B 3/42; H05B 3/44

(52) U.S. Cl. CPC A01K 39/012; A01K 39/014; H05B 3/06; H05B 3/42; H05B 3/44; H05B 2203/023

(57) ABSTRACT

The present disclosure relates to a bird heating apparatus. The bird heating apparatus includes a support rod, and a heating device. The support rod is configured to support a bird. The heating device is provided with a first heating element. The heating device is configured to provide warmth for the bird.

### CROSS-REFERENCE TO RELATED APPLICATIONS

The application claims priority of Chinese patent application CN2025202654189, filed on Feb. 18, 2025, disclosure of which is incorporated herein by reference in its entirety.

### TECHNICAL FIELD

The present disclosure relates to the technical field of pet supplies for birds, and more particularly, to a bird heating apparatus.

### BACKGROUND

Nowadays, more and more people are keeping pets. Cats, pet dogs, and birds are among the pets that are relatively favored by humans. However, due to differences in ambient temperature across various regions or seasons, when the ambient temperature is low, pets are susceptible to illness or even death because of the low temperature. Therefore, there is an urgent need in the market for a product capable of providing warmth for pet birds.

### SUMMARY

To overcome deficiencies in the prior art, the technical solution adopted by the present disclosure to address its technical problems is as follows.

The present disclosure provides a bird heating apparatus including a support rod and a heating device. The support rod is configured to support a bird. The heating device is provided with a first heating element and is configured to provide warmth for the bird.

Accordingly, by arranging the support rod and the heating device with the first heating element disposed within the heating device, the bird heating apparatus allows a bird to receive warmth from the heating device while perching on the support rod. This configuration provides a rational and effective structural arrangement for the bird heating apparatus.

### BRIEF DESCRIPTION OF THE DRAWINGS

Implementations of the present disclosure will now be described, by way of embodiment, with reference to the attached figures. It should be understood, the drawings are shown for illustrative purpose only, for ordinary person skilled in the art, other drawings obtained from these drawings without paying creative labor by an ordinary person skilled in the art should be within scope of the present disclosure.

FIG. 1 is a schematic diagram of an overall structure of Embodiment 1 of the present disclosure.

FIG. 2 is another schematic diagram of the overall structure of Embodiment 1 of the present disclosure.

FIG. 3 is an exploded view of Embodiment 1 of the present disclosure.

FIG. 4 is another exploded view of Embodiment 1 of the present disclosure.

FIG. 5 is a schematic diagram of a connection between a first heating device and a first fastening member in Embodiment 1 of the present disclosure.

FIG. 6 is a cross-sectional view taken along a section line of the first heating device in Embodiment 1 of the present disclosure.

FIG. 7 is a schematic diagram of the bird heating apparatus installed on a birdcage grating in Embodiment 1 of the present disclosure.

FIG. 8 is an exploded view of Embodiment 2 of the present disclosure.

FIG. 9 is a structural schematic diagram of a heating rod in Embodiment 2 of the present disclosure.

FIG. 10 is an assembly cross-sectional view of the heating rod and a heating plate in Embodiment 2 of the present disclosure.

FIG. 11 is a structural schematic diagram of the heating plate in Embodiment 2 of the present disclosure.

FIG. 12 is a structural schematic diagram of Embodiment 3 of the present disclosure.

FIG. 13 is a structural schematic diagram of another embodiment of the present disclosure.

### DETAILED DESCRIPTION OF THE EMBODIMENTS

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”. In addition, the terms “first” and “second” are used for descriptive purposes only and cannot be understood as indicating or implying relative importance or implying the number of indicated technical features. Thus, the features defined as “first” and “second” may explicitly or implicitly include one or more of the features. In the description of embodiments of the application, “a plurality of” means two or more, unless otherwise specifically defined.

### Embodiment 1

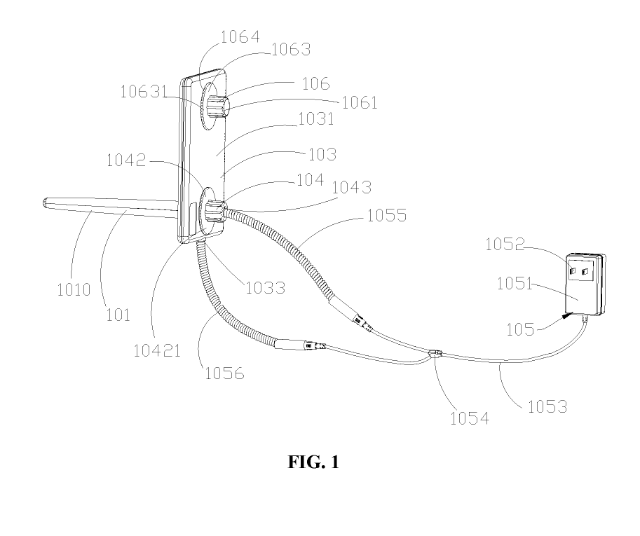

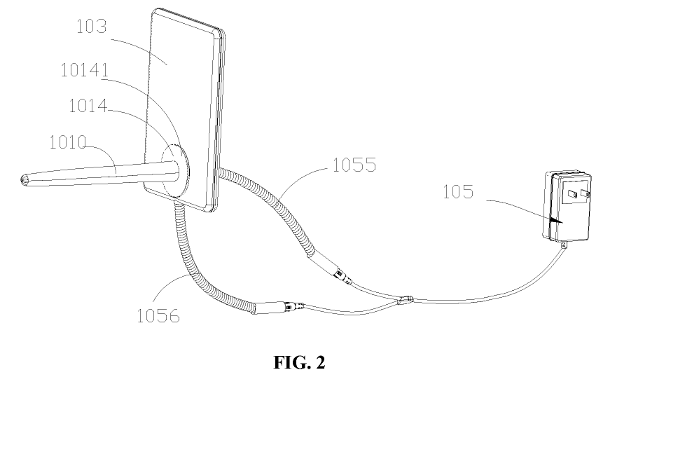

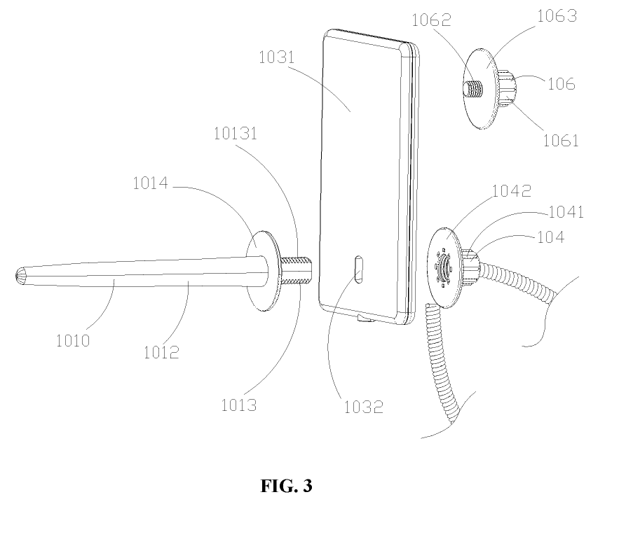

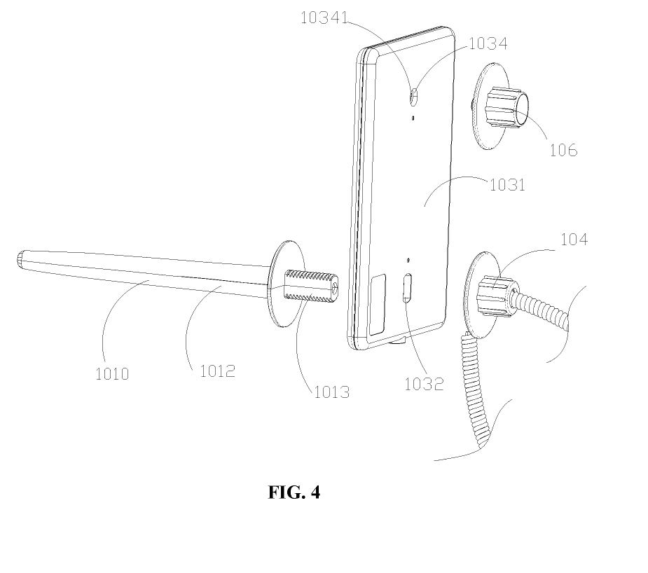

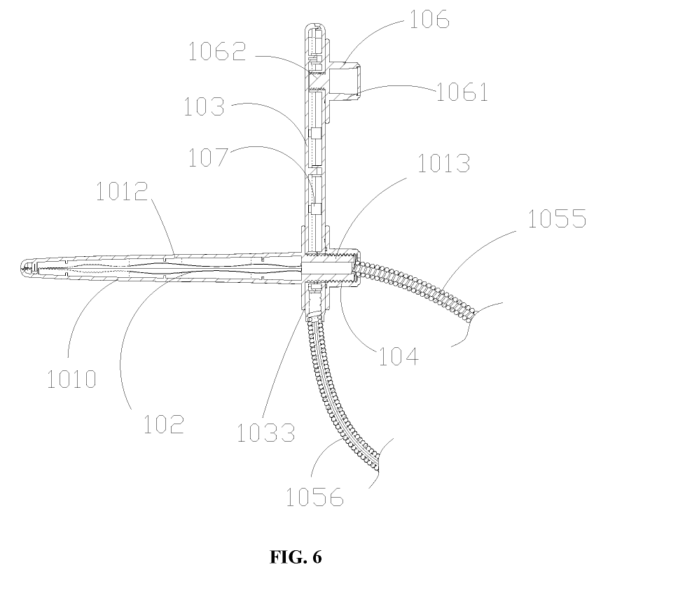

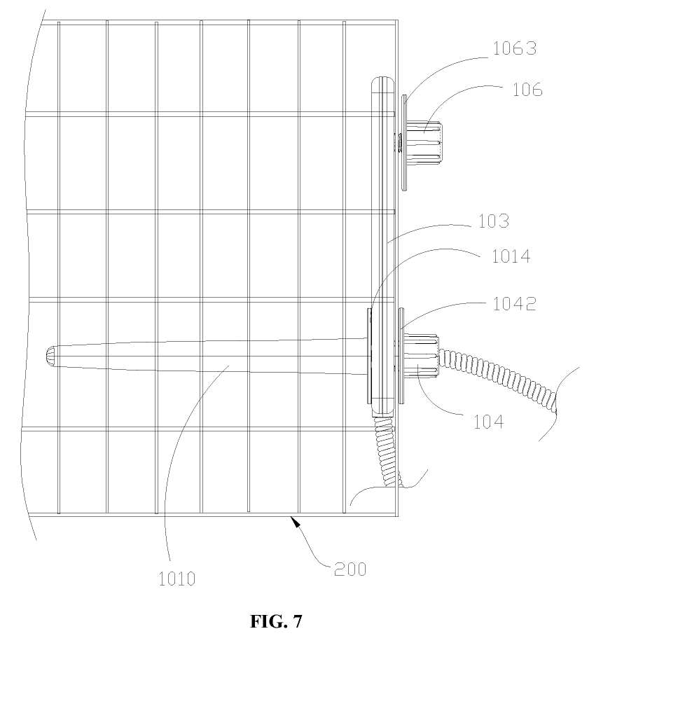

Referring to FIGS. 1 to 7, a bird heating apparatus includes a support rod 1010 and a heating device 103. The support rod 1010 is configured to support a bird. The heating device 103 is provided with a first heating element 107 and is configured to provide warmth for the bird. With the above structure, by arranging the support rod 1010 and the heating device 103 and by arranging the first heating element 107 inside the heating device 103, the bird may receive warmth from the heating device 103 while perching on the support rod 1010, effectively achieving a reasonable structural arrangement for the bird heating apparatus.

Further, the support rod 1010 is a heating support rod 101, the heating support rod 101 is provided with the second heating element 102, the heating support rod 101 is configured to provide warmth for the bird. The support rod 1010 is connected to the heating device 103. With the above structure, by arranging the heating device 103 and the heating support rod 101, and respectively arranging the first heating element 107 and a second heating element 102, more comprehensive heating of the bird’s activity space or perching area may be achieved; simultaneously, forming the support rod 1010 and the heating device 103 into an integral structure is beneficial for improving the stability of the overall structure, facilitating overall installation, detachment, and maintenance, and improving convenience of use.

In another embodiment, the support rod 1010 and the heating device 103 are arranged independently of each other. With the above structure, the independently arranged structure allows a user to install the apparatus at different positions inside a birdcage according to the actual needs of the bird, improving the practicality of the product.

In the present embodiment, the first heating element 107 is selected from the group consisting of: a heating wire, a heating tube, and a heating film arranged inside the heating device 103; the second heating element 102 is selected from the group consisting of: a heating wire, a heating tube, and a heating film arranged inside the heating support rod 101.

In the present embodiment, the support rod 1010 is detachably connected to the heating device 103. With the above structure, the support rod 1010 and the heating device 103 is optionally flexibly combined or separated according to actual usage requirements, facilitating installation, detachment, and subsequent maintenance or replacement, reducing maintenance costs.

In the present embodiment, the support rod 1010 and the heating device 103 are integrally formed. With the above structure, by integrally forming the support rod 1010 and the heating device 103, the support rod 1010 and the heating device 103 form a monolithic structure. The monolithic structure is beneficial for improving the structural strength of the overall bird heating apparatus, reducing risks such as loosening or detachment at connection points; simultaneously, the integrally formed structure may reduce manufacturing and assembly costs.

In the present embodiment, the support rod 1010 is fixedly connected to the heating device 103. With the above structure, by fixedly connecting the heating device 103 and the support rod 1010, the relative position between the heating device 103 and the support rod 1010 remains stable during use. This arrangement is beneficial for improving the stability of the overall structure, avoiding connection loosening or separation due to vibration or external force.

In the present embodiment, the heating device 103 is a heating plate 1031, the support rod 1010 is connected to a side surface of the heating plate 1031. In one or more embodiments, the support rod 1010 is a cylindrical support rod 1010. With the above structure, since the support rod 1010 is connected to the side surface of the heating plate 1031, the bird may simultaneously receive warmth from the heating support rod 101 and the heating plate 1031 while standing or perching, improving the comprehensiveness and comfort of heat retention. This structure achieves a reasonable combination of the heating support rod 101 and the heating plate 1031, enhancing the functionality and practicality of the bird heating apparatus.

In the present embodiment, the bird heating apparatus further includes a first fastening member 104, the heating support rod 101 includes a heating segment portion 1012 and a connection portion 1013. The heating plate 1031 has a through hole 1032, the connection portion 1013 passes through the through hole 1032 and is detachably connected to the first fastening member 104, the first fastening member 104 is configured to fix the heating support rod 101 onto the heating plate 1031. Specifically, an outer periphery of the connection portion 1013 is circumferentially provided with an external thread segment 10131, the first fastening member 104 is a first nut 1041, after the connection portion 1013 passes through the through hole 1032, the first nut 1041 threadedly engages with the external thread segment 10131, to clamp the heating plate 1031 between the heating segment portion 1012 and the first nut 1041. With the above structure, after the connection portion 1013 of the heating support rod 101 passes through the through hole 1032 of the heating plate 1031 and threadedly engages with the first fastening member 104, the heating support rod 101 is optionally stably fixed onto the heating plate 1031, ensuring the stability and safety of the heating support rod 101 during use, preventing shaking or detachment, allowing a pet bird to perch on the heating segment portion 1012 while receiving warmth from the bottom and the side.

In the present embodiment, an outer periphery of the heating support rod 101 is provided with a first clamping member 1014, an outer periphery of the first fastening member 104 is provided with a second clamping member 1042, when the first fastening member 104 is lockingly connected to the connection portion 1013, the first clamping member 1014 and the second clamping member 1042 form a first clamping space 1044. Specifically, the first clamping member 1014 is a first pressing plate 10141 circumferentially arranged on the outer periphery of the heating segment portion 1012, the second clamping member 1042 is a second pressing plate 10421. During use, the bird heating apparatus is placed adjacent to a birdcage grating 200 position, the connection portion 1013 of the heating support rod 101 is passed through the through hole 1032 of the heating plate 1031 and the birdcage grating 200, then threadedly engages and locks with the first fastening member 104, causing the first clamping member 1014 and the second clamping member 1042 to form a clamping space, firmly clamping the heating plate 1031 and the birdcage grating 200 within the first clamping space 1044, thereby stably clamping the heating apparatus onto the birdcage. With the above structure, installation and fixation of the bird heating apparatus on the birdcage is effectively achieved, effectively preventing shaking or detachment during use, while facilitating detachment and maintenance, improving the convenience of use of the bird heating apparatus.

In the present embodiment, the apparatus further includes a power supply module 105, the power supply module 105 is electrically connected to the first heating element 107 and the second heating element 102, the power supply module 105 is configured to simultaneously supply power to the first heating element 107 and the second heating element 102. With the above structure, the bird heating apparatus may heat synchronously, ensuring uniform and stable heating effect. During use, only one power socket needs to be connected to complete power supply, improving convenience of use.

In the present embodiment, the power supply module 105 includes a power supply plug 1052, the power supply plug 1052 is configured to be compatible with 100V-230V mains electricity. Further, the power supply module 105 further includes an adapter 1051, the adapter 1051 is configured to convert an input voltage from the power supply plug 1052 into a voltage selected from the group consisting of: 12V, 24V, and 36V, and output the converted voltage. With the above structure, the bird heating apparatus may adapt to high-voltage power supply environments, ensuring stable power supply to the heating elements and heating effect, reducing safety risks caused by voltage mismatch.

Further, the power supply module 105 extends with an output cable 1053, a distal end of the output cable 1053 away from the power supply module 105 is provided with a branch node 1054, the output cable 1053 is electrically connected to a first conductive wire 1055 and a second conductive wire 1056 via the branch node 1054, the first conductive wire 1055 is electrically connected to the second heating element 102, the second conductive wire 1056 is electrically connected to the first heating element 107. With the above structure, by arranging the branch node 1054 on the output cable 1053 of the power supply module 105, power is distributed to the first conductive wire 1055 and the second conductive wire 1056 respectively, and then to the first heating element 107 and the second heating element 102 respectively, thereby effectively achieving common power supply to the first heating element 107 and the second heating element 102; simultaneously, this structure makes the wiring layout clear and the power supply reliable.

In the present embodiment, the support rod 1010 is the heating support rod 101, the heating device 103 is the heating plate 1031, the bird heating apparatus further includes the first fastening member 104, the heating support rod 101 includes the heating segment portion 1012 and the connection portion 1013, the heating plate 1031 has the through hole 1032, the connection portion 1013 passes through the through hole 1032 and is connected to the first fastening member 104, the first fastening member 104 fixes the heating support rod 101 onto the heating plate 1031; the first fastening member 104 is provided with a first connection hole 1043, the first conductive wire 1055 passes through the first connection hole 1043 to be electrically connected to the second heating element 102; a bottom portion of the heating plate 1031 is provided with a second connection hole 1033, the second conductive wire 1056 passes through the second connection hole 1033 to be electrically connected to the first heating element 107. With the above structure, power supply to the heating support rod 101 and the heating plate 1031 is effectively achieved, making the bird heating apparatus compact and installation simple.

In the present embodiment, the bird heating apparatus further includes a second fastening member 106, the heating plate 1031 is provided with an installation hole 1034, the second fastening member 106 is detachably connected to the installation hole 1034, so that the second fastening member 106 is detachably connected to the heating plate 1031. Specifically, an inner periphery of the installation hole 1034 is provided with an internal thread segment 10341, the second fastening member 106 includes a hand-tightening portion 1061 and a screw rod 1062 connected to the hand-tightening portion 1061, the screw rod 1062 passes through the installation hole 1034 and threadedly engages with the internal thread segment 10341. Further, an outer periphery of the second fastening member 106 is provided with a third clamping member 1063, when the second fastening member 106 is connected to the installation hole 1034, the third clamping member 1063 and a side wall of the heating plate 1031 form a second clamping space 1064; the third clamping member 1063 is a third pressing plate 10631. With the above structure, the screw rod 1062 of the second fastening member 106 is passed through the installation hole 1034 of the heating plate 1031 and threadedly engages and locks with the internal thread segment 10341, causing the third clamping member 1063 and the side wall of the heating plate 1031 to form the second clamping space 1064, further stably clamping the bird heating apparatus onto the birdcage grating 200, thereby ensuring that the bird heating apparatus does not shake or detach during use, with a stable and reliable structure.

In the present embodiment, the support rod 1010 is a plastic support rod 1010, or a metal support rod 1010, or a wooden support rod 1010, or a silicone support rod 1010, or a rubber support rod 1010, or a ceramic support rod 1010, or a glass support rod 1010; the heating device 103 is a plastic heating device 103, or a metal heating device 103, or a wooden heating device 103, or a silicone heating device 103, or a rubber heating device 103, or a ceramic heating device 103, or a glass heating device 103. With the above structure, the bird heating apparatus may select appropriate materials according to different usage requirements and environments, thereby ensuring heating efficiency, durability, comfort, and safety.

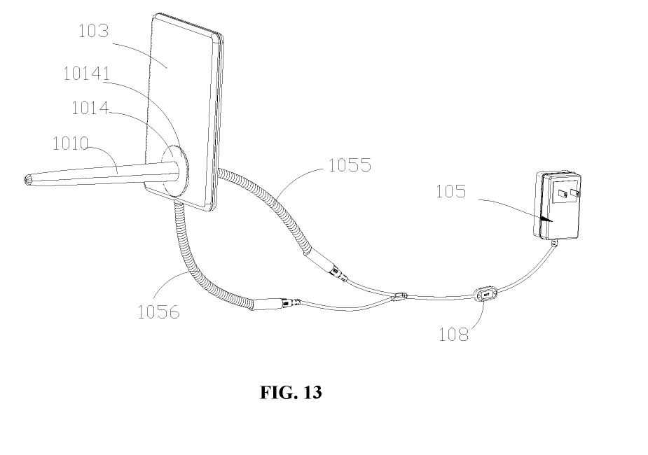

In another embodiment, referring to FIG. 13, the bird heating apparatus further includes a controller 108 electrically connected to the power supply module 105, the controller 108 may control operational parameters of the first heating element 107 and the second heating element 102, such as heating temperature and heating time, thereby facilitating a user to adjust the most suitable heating temperature and heating time for pet birds according to different scenarios and temperatures, improving the portability and practicality of the bird heating apparatus.

### Embodiment 2

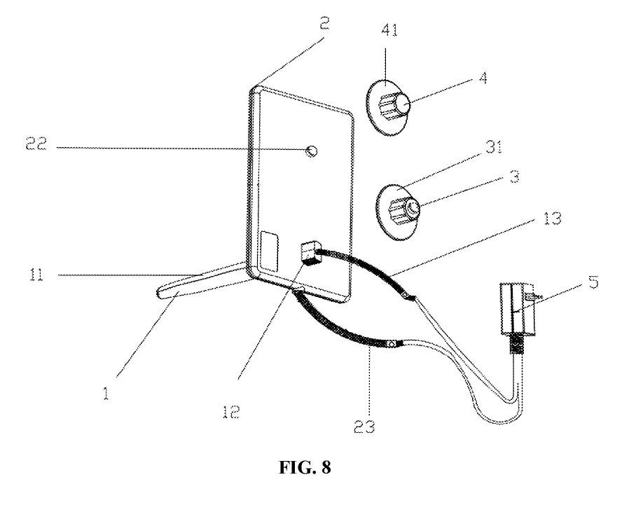

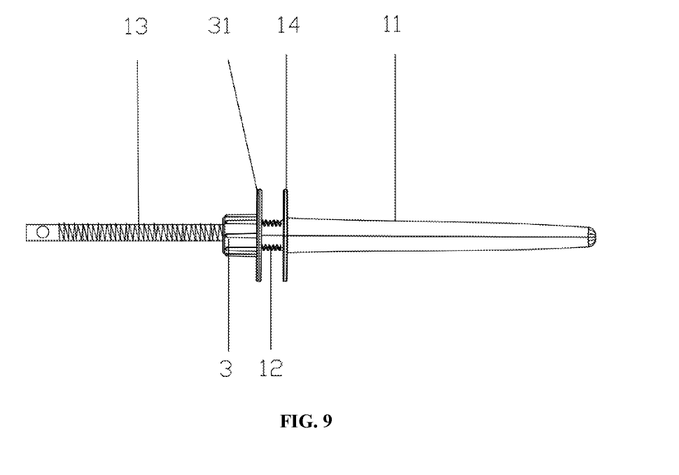

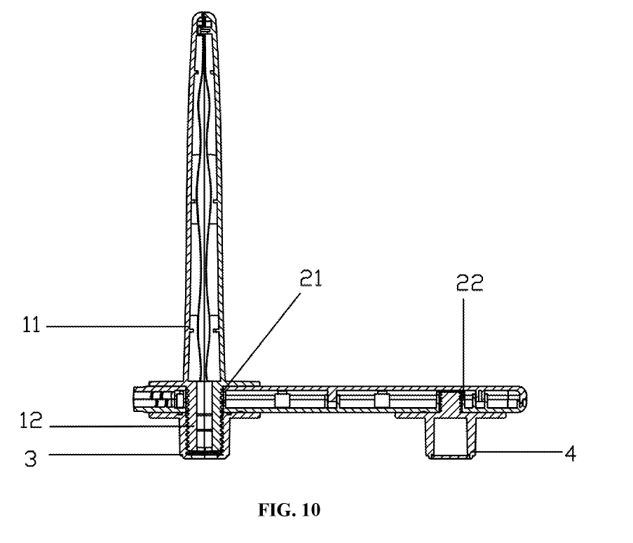

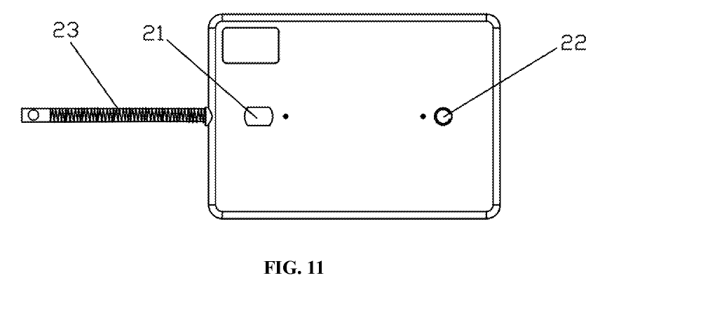

As shown in FIGS. 8-11, the present disclosure provides a novel bird heating apparatus, and the novel bird heating apparatus includes a heating rod 1, a heating plate 2 and a nut 3. The heating plate 2 is provided with a through hole 21. The heating rod 1 includes a heating segment 11 and a threaded segment 12, both the interior of the heating segment 11 and the interior of the heating plate 2 are provided with a heating module. The heating segment 11 is fixedly connected to the threaded segment 12, and the threaded segment 12 of the heating rod 1 passes through the through hole 21 and threadedly engages with the nut 3. An outer diameter of the nut 3 is greater than a width of a gap between gratings on a side of a birdcage. During installation, the threaded segment 12 is passed through the through hole 21 and the gratings, and the threaded segment 12 is threadedly engaged with the nut 3, the nut 3 and the heating plate 2 clamp the gratings on the side of the birdcage, thereby forming fixation. When a bird perches on the heating rod 1, the heating segment 11 may heat the feet of the bird, and the heating plate 2 may heat the body of the bird.

Specifically, the heating rod 1 further includes a rod conductive wire 13, and the rod conductive wire 13 is electrically connected to the heating module inside the heating segment 11 and passes through the threaded segment 12; the heating plate 2 is further provided with a plate conductive wire 23, and the plate conductive wire 23 is electrically connected to the heating module inside the heating plate 2 and passes through a housing of the heating plate 2. Both the rod conductive wire 13 and the plate conductive wire 23 are configured to supply power to the heating module. The heating module is selected from the group consisting of: an electric heating film, an electric heating wire, an electric heating tube, and a Positive Temperature Coefficient (PTC) heater.

In one or more embodiments, the heating apparatus further includes a power plug 5, both the rod conductive wire 13 and the plate conductive wire 23 are electrically connected to the power plug 5. Since both the rod conductive wire 13 and the plate conductive wire 23 are electrically connected to the same power plug 5, only one power socket needs to be connected during use, providing greater convenient. In another embodiment, it is not necessary to arrange the rod conductive wire 13 in an extended configuration on the bird heating apparatus, the power plug 5 may be directly arranged on the bird heating apparatus, allowing the bird heating apparatus to be directly electrically connected to an external power socket, saving occupied space, and being applicable to different application scenarios.

In one or more embodiments, the heating rod 1 further includes a rod pressing plate 14, and the rod pressing plate 14 is circumferentially arranged on an outer side surface of the heating segment 11. The rod pressing plate 14 is configured to press against the heating plate 2, making the fixation more stable.

In one or more embodiments, the nut 3 is provided with a nut pressing plate 31, the nut pressing plate 31 is circumferentially arranged on an outer side surface of the nut 3. The nut pressing plate 31 is configured to press against the gratings on the side of the birdcage, making the fixation more stable.

In one or more embodiments, the novel bird heating apparatus further includes a screw 4, the heating plate 2 is further provided with a screw hole 22, the screw 4 threadedly engages with the screw hole 22 of the heating plate 2. The screw 4 and the nut 3 serve a two-point fixation function, allowing the bird heating apparatus to be installed more stably.

In one or more embodiments, the screw 4 is provided with a screw pressing plate 41, the screw pressing plate 41 is circumferentially arranged on an outer side surface of the screw 4. The screw pressing plate 41 is configured to press against the gratings on the side of the birdcage, making the fixation more stable.

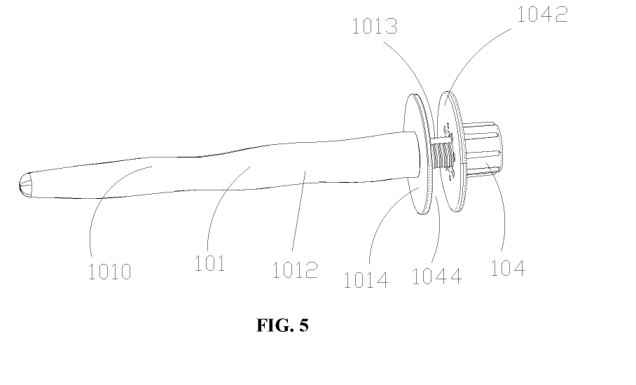

In one or more embodiments, as shown in FIG. 5, the threaded segment 12 has a flat shape. A traditional heating rod has a threaded segment end provided with a clamping slit, the clamping slit is configured to clamp a vertical rod of a grating, the entire threaded segment occupies a large space; the threaded segment 12 of the present disclosure has a flat shape, both side surfaces are parallel to the gratings, and a width of the threaded segment 12 is less than a width of the gap between the gratings, therefore the threaded segment 12 may protrude from the gap between the gratings of the birdcage, occupying less space.

In one or more embodiments, a housing of the heating rod 1 and a housing of the heating plate 2 are both formed from heat-resistant plastic. Traditional heating rods and heating plates use metal material for the housing, and an outer surface is plated with aluminum, when a bird pecks at the heating rod or heating plate, the aluminum film on the surface may form powder and fall off, resulting in a “powder shedding” phenomenon; in contrast, the bird heating apparatus of the present disclosure is less prone to the “powder shedding” phenomenon, and has an overall smaller weight, being less likely to cause deformation of the birdcage.

### Embodiment 3

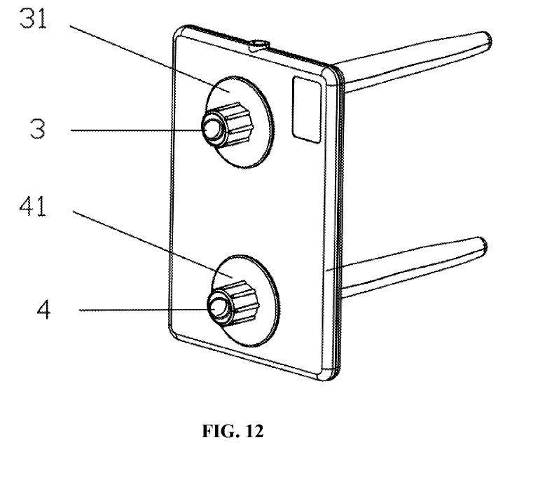

As shown in FIG. 12, in the present embodiment, a total number of both the heating rods 1 is two, and a total number of the nuts 3 is also are provided in a quantity of two. A birdcage may simultaneously accommodate a plurality of birds and provide warmth for the plurality of birds. In other embodiments, the heating rods 1 and the nuts 3 may each also be provided in a quantity of three or more. It is worth mentioning that when the heating rods 1 and the nuts 3 are provided in a plural number, arranging the screw 4 is not necessary to also achieve a multi-point fixation effect. Correspondingly, the power plug 5 is provided with a plurality of connectors, and is capable of simultaneously connecting to the heating plate 2 and the plurality of heating rods 1.

The above description only describes embodiments of the present disclosure, and is not intended to limit the present disclosure; various modifications and changes can be made to the present disclosure. Any modifications, equivalent substitutions, and improvements made within the spirit and scope of the present disclosure are intended to be included within the scope of the present disclosure.

1. A bird heating apparatus, comprising:
a support rod, the support rod being configured to support a bird; and
a heating device, the heating device being provided with a first heating element, the heating device being configured to provide warmth for the bird.

2. The bird heating apparatus according to claim 1, wherein the support rod is a heating support rod; the heating support rod is provided with a second heating element; the heating support rod is configured to provide warmth for the bird.

3. The bird heating apparatus according to claim 1, wherein the support rod is connected to the heating device; or the support rod and the heating device are arranged independently of each other.

4. The bird heating apparatus according to claim 1, wherein the support rod is detachably connected to the heating device.

5. The bird heating apparatus according to claim 1, wherein the support rod and the heating device are integrally formed.

6. The bird heating apparatus according to claim 1, wherein the support rod is fixedly connected to the heating device.

7. The bird heating apparatus according to claim 1, wherein the heating device is a heating plate, and the support rod is connected to a side surface of the heating plate.

8. The bird heating apparatus according to claim 2, wherein the heating device is a heating plate, and the heating support rod is connected to a side surface of the heating plate; the bird heating apparatus further comprises a first fastening member; the heating support rod comprises a heating segment portion and a connection portion; the heating plate has a through hole; the connection portion passes through the through hole and is detachably connected to the first fastening member; the first fastening member is configured to fix the heating support rod onto the heating plate.

9. The bird heating apparatus according to claim 8, wherein an outer periphery of the connection portion is circumferentially provided with an external thread segment; the first fastening member is a first nut; after the connection portion passes through the through hole, the first nut threadedly engages with the external thread segment to clamp the heating plate between the heating segment portion and the first nut.

10. The bird heating apparatus according to claim 8, wherein an outer periphery of the heating support rod is provided with a first clamping member; an outer periphery of the first fastening member is provided with a second clamping member; when the first fastening member is lockingly connected to the connection portion, the first clamping member and the second clamping member form a first clamping space.

11. The bird heating apparatus according to claim 10, wherein the first clamping member is a first pressing plate circumferentially arranged on an outer periphery of the heating segment portion; the second clamping member is a second pressing plate.

12. The bird heating apparatus according to claim 2, further comprising a power supply module; the power supply module is electrically connected to the second heating element and the first heating element; the power supply module is configured to simultaneously supply power to the second heating element and the first heating element.

13. The bird heating apparatus according to claim 12, wherein the power supply module comprises a power supply plug; the power supply plug is configured to be compatible with 100V-230V mains electricity.

14. The bird heating apparatus according to claim 12, wherein the power supply module extends with an output cable; a distal end of the output cable away from the power supply module is provided with a branch node; the output cable is electrically connected to a first conductive wire and a second conductive wire via the branch node; the first conductive wire is electrically connected to the second heating element; the second conductive wire is electrically connected to the first heating element.

15. The bird heating apparatus according to claim 14, wherein the support rod is a heating support rod; the heating device is a heating plate; the bird heating apparatus further comprises a first fastening member; the heating support rod comprises a heating segment portion and a connection portion; the heating plate has a through hole; the connection portion passes through the through hole and is connected to the first fastening member, the first fastening member fixing the heating support rod onto the heating plate; the first fastening member is provided with a first connection hole, the first conductive wire passing through the first connection hole to be electrically connected to the second heating element; a bottom portion of the heating plate is provided with a second connection hole, the second conductive wire passing through the second connection hole to be electrically connected to the first heating element.

16. The bird heating apparatus according to claim 7, further comprising a second fastening member; the heating plate is provided with an installation hole; the second fastening member is detachably connected to the installation hole, so that the second fastening member is detachably connected to the heating plate.

17. The bird heating apparatus according to claim 16, wherein an inner periphery of the installation hole is provided with an internal thread segment; the second fastening member comprises a hand-tightening portion and a screw rod connected to the hand-tightening portion; the screw rod passes through the installation hole and threadedly engages with the internal thread segment.

18. The bird heating apparatus according to claim 16, wherein an outer periphery of the second fastening member is provided with a third clamping member; when the second fastening member is connected to the installation hole, the third clamping member and a side wall of the heating plate form a second clamping space; the third clamping member is a third pressing plate.

19. The bird heating apparatus according to claim 1, wherein the support rod is selected from the group consisting of: a plastic support rod, a metal support rod, a wooden support rod, a silicone support rod, a rubber support rod, a ceramic support rod, and a glass support rod; and wherein the heating device is selected from the group consisting of: a plastic heating device, a metal heating device, a wooden heating device, a silicone heating device, a rubber heating device, a ceramic heating device, and a glass heating device.

20. The bird heating apparatus according to claim 13, wherein the power supply module further comprises an adapter, the adapter being configured to convert an input voltage from the power supply plug into a voltage selected from the group consisting of: 12V, 24V, and 36V, and output the converted voltage.
